(19) United States
(12) Patent Application Publication
(10) Pub. No.: US 2010/0077229 A1
(43) Pub. Date: Mar. 25, 2010

(54) METHOD FOR EMPLOYING USB RECORD CARRIERS AND A RELATED MODULE

(75) Inventors: HONG-CHI YU, Kaohsiung (TW); MAO-TING CHANG, Kaohsiung (TW)

Correspondence Address: Yen Jung Sung, 21-80 38 St, #C8, Astoria, NY, 11105, US

(73) Assignee: WALTON ADVANCED ENGINEERING, INC., Kaohsiung (TW)

(21) Appl. No.: 12/479,760

(22) Filed: Jun. 5, 2009

(30) Foreign Application Priority Data
Sep. 25, 2008 (TW) 097136990

(51) Int. Cl. G06F 12/14

(52) U.S. Cl. 713/193

(57) ABSTRACT

A method of utilizing USB record carriers is disclosed. A USB security drive is serially connected with at least a USB drive to encrypt/decrypt stored data in the USB drive and to integrate a plurality of data regions or even a plurality of encrypted data regions to provide multi-level security protections. In a more specific embodiment, the USB security drive further enables the automatic backup of data stored in the USB drive. A related assembled module by the implementation is also disclosed.

### FIELD OF THE INVENTION

The present invention relates to a method of utilizing record carriers, and in particular to a method of utilizing USB (Universal Serial Bus) record carriers to serially integrate two or more USB drives for the encryption and decryption of data, for expanded memory capabilities, and for the automatic backup of stored data.

### BACKGROUND OF THE INVENTION

Many semiconductor memory storage devices exist, such as USB drives, SD, mini SD, Micro SD (TransFlash), MS, CF, MMC, etc. as memory cards for data access and storage in electronic devices, such as computers, digital cameras, and cellular phones. The demands of portable memory devices are increasing, and USB drives are the most popular and widely implemented micro portable memory storage devices. However, existing memory storage devices are individually but not collectively used. In a USB drive disclosed in US Publication Patent No. 2004/0034738 A1 by Huang, a plurality of USB drives are connected in series without occupying USB sockets on a system. However, although a plurality of USB drives are connected in series, only individual USB drives are displayed and accessed, without any integration or management of the memory capabilities of the USB drives. Furthermore, no encryption or decryption of the USB drives for data access purposes is supported, and thus data can easily be accessed and exposed. A conventional USB security drive has a standard data region and an encrypted/decrypted data region, which only can be used individually but not in series.

Moreover, as revealed in Taiwan Publication Patent No. 200702994 “A portable storage device with data protection”, a transfer module having a built-in specific firmware for a portable storage device is used as an active sector. When the transfer module is connected to a system, a security IC key is inserted into the module for activating the portable storage device. The assembled module has the encryption/decryption mechanism in the portable storage device separate from the security IC key. However, each portable storage device is limited to accessing one standard data region and one encrypted data region and can only be used individually but not in series.

### SUMMARY OF THE INVENTION

An objective of the present invention is to provide a method of utilizing USB record carriers and a related module, with USB modules in series. The USB security drive can perform data encryption/decryption and memory capacity integration for at least one of serially connected USB drives to achieve multi-level security protection of data.

A second objective of the present invention is to provide a method of utilizing USB record carriers and a related assembly, such that the memory capacity of at least one of the serially connected USB drives can be integrated and increased to achieve a larger memory capacity; and the memory partition can easily be managed between a standard data region and an encrypted data region to provide flexible memory capacities as required.

A third purpose of the present invention is to provide a method of utilizing USB record carriers and a related assembly that the data stored in at least one of serially connected USB drives can be automatically backed up to USB drives defined by the user to achieve higher security requirements for data access. A perspective view of an assembled module of embodiment USB drives in a series connection is shown in FIG. 1. A flow chart of a storage algorithm is shown in FIG. 2. An operating flow chart of a built-in configuration driver is shown in FIG. 5 for initialization, in FIG. 10 for an automatic backup management process, and in FIG. 11 for an automatic backup process.

According to the present invention, a method of utilizing USB record carriers comprises:

Providing a USB security drive, comprising a driver region where the driver region comprises a configuration driver, an encryption/decryption driver, and a memory management driver.

Providing a first data region formed in the first USB drive, the first USB drive comprising a first configuration data region, a first standard data region, a first encrypted/data region, and a first security code region.

Providing a second data region formed in a second USB drive or in the USB security drive where the second data region comprises a second configuration data region and a second standard data region.

Combining the USB security drive and the first USB drive in a serial connection; wherein the configuration driver in the driver region of the USB security drive reads the first configuration data region to make a security check and sends a security code for protecting the first encrypted data region. Moreover, the memory management driver integrates the first standard data region and the second standard data region as a single disk region in a serial connection. An assembled module using the implementation is also disclosed.

An implementation of USB record carriers and a related assembled module of the present invention have the following advantages and functions:

1. The USB security drive can execute data encryption/decryption and memory capacity integration of at least one of the USB drives in a series connection to achieve multi-level security protection of data access to USB drives in series connections through the individually designed USB components.

2. The memory capacity of at least one of the USB drives in a series connection can be integrated and increased to achieve a larger memory capacity, where the memory partition can be easily managed between the standard data region and the encrypted data region to flexibly adjust the memory capacities as required.

3. The data stored in at least one of the serially connected USB drives can be automatically backed up according to user defined USB drives to achieve higher security requirements for data access.

### DESCRIPTION OF THE DRAWINGS

FIG. 1 is a perspective view of an assembled module where a USB security drive being combined with one or more USB drives in a serial connection according to the present invention.

FIG. 2 is a component block diagram of assembled modules according to the present invention.

FIG. 3 is a component block diagram of assembled modules according to a second embodiment of the present invention.

FIG. 4 is a more specific component block diagram of a first USB drive according to a second embodiment of the present invention.

FIG. 5 is an initialization process flowchart according to the present invention.

FIG. 6 is an encryption/decryption process flowchart according to the present invention.

FIG. 7 is a data encryption algorithm process flowchart between different USB drives according to the present invention.

FIG. 8 is a data decryption algorithm process flowchart between different USB drives according of the present invention.

FIG. 9 is a memory capacity expansion management process flowchart according to the present invention.

FIG. 10 is an automatic backup management process flowchart according to of the present invention.

FIG. 11 is another automatic backup operating process flowchart according to the present invention.

### DETAILED DESCRIPTION OF THE INVENTION

With reference to the attached drawings, the present invention is described by means of the embodiments below.

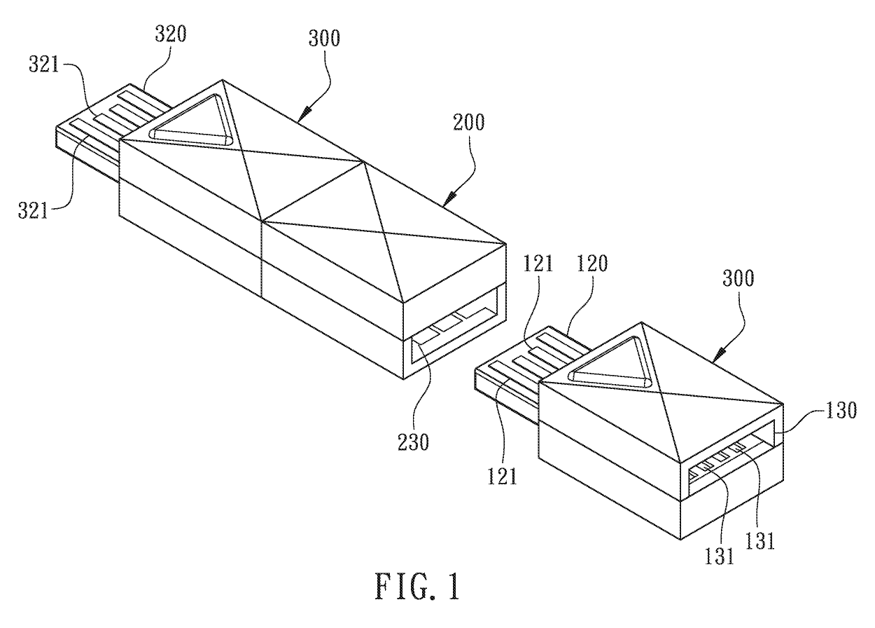

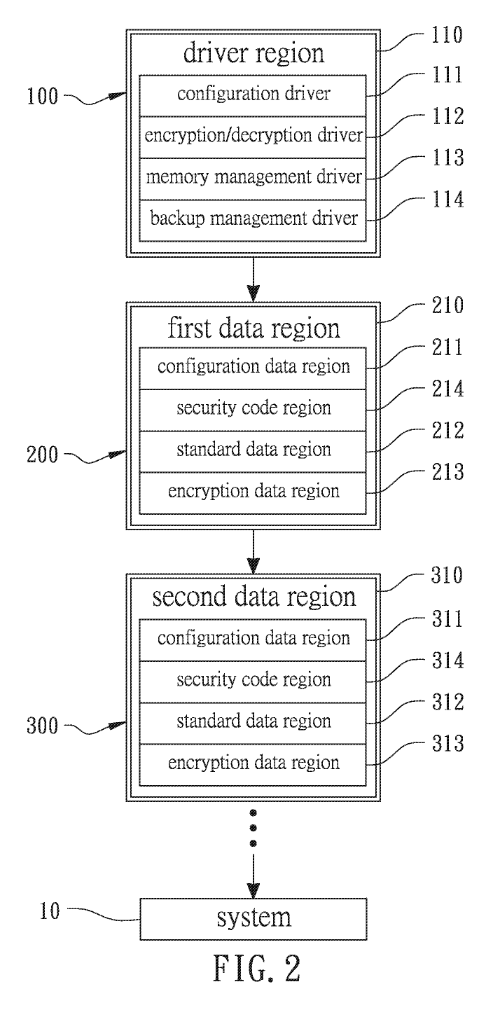

According to a first embodiment of the present invention, a method for utilizing USB record carriers is illustrated in FIG. 1 with a perspective view of an assembled module, and in FIG. 2 with a component block diagram, in which USB stands for “Universal Serial Bus”.

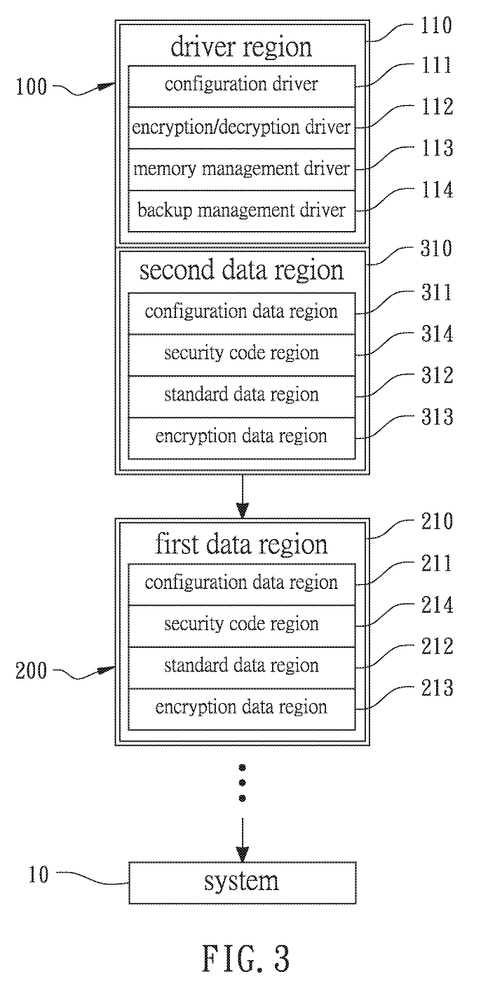

As shown in FIG. 1 and FIG. 2, at least one USB drive and a USB security drive 100 are utilized. In the first embodiment, two or more USB drives are provided, which comprise at least a first USB drive 200 and a second USB drive 300, where a first data region 210 is in the first USB drive 200 and a second data region 310 is in the second USB drive 300. In a second embodiment, as shown in FIG. 3, only one USB drive is provided, which comprises only the first USB drive 200, where the first data region 210 is in the first USB drive 200 but the second data region 310 can be in the USB security drive 100. The second data region 310 is formed either in the second USB drive 300 or in the USB security drive 100,but the second data region 310 and the first data region are not in the same USB drive.

As shown in FIG. 2, the USB security drive 100 comprises a driver region 110 and a USB connector 120 used for series connections. The driver region 110 is an active sector having disk management drivers for the first data region 210 and the second data region 310. To be more specific, the driver region 110 comprises a configuration driver 111, an encryption/decryption driver 112, and a memory management driver 113, wherein the memory management driver 113 integrates the memory capacities of the first data region 210 and the second data region 310. As shown in FIG. 1, the USB security drive 100 has the same or similar appearance as the first USB drive 200. To be more specific, the driver region 110 further has a backup management driver 114 to automatically backup the first data region 210 and the second data region 310.

As shown in FIG. 1, the first USB drive 200 has a USB connector and a USB socket 230 disposed at two opposite ends for USB series connections. As shown in FIG. 2, the first data region 210 in the first USB drive 200 comprises a first configuration data region 211, a first standard data region 212, a first encrypted data region 213, and a security code region 214. In the present embodiment, the data stored in the first configuration data region 211 can be accessed by the configuration driver 111; for example, any vendors or systems having built-in data that met standard requirements can activate the configuration driver 111. When the built-in data in the first configuration data region 211 does not meet the standard requirements or can not be accessed due to hardware incompatibilities, the driver region 110 can not be activated, and the first encrypted data region 213 is hidden from users to cause the first USB drive 200 to appear as a conventional passive USB drive to provide security and masquerading functions. In the present embodiment, the first USB drive 200 has a USB connector and a USB socket 230 disposed at two opposite ends. The first security code region 214 is electrically connected to the USB socket 230 of the first USB drive 200 and connected to contact terminals 121 of the USB socket 120 of the USB security drive 100 to activate the encryption/decryption driver 112. The data stored in the first encrypted data region 213 is protected by the first security code region 214 or by other security codes, including passwords. When the encryption/decryption driver 112 can not be correctly activated and executed, the data stored in the first encrypted data region 213 can not be accessed, copied, nor modified to achieve basic security protections. However, the first standard data region 212 is not restricted.

As shown in FIG. 1 and FIG. 2, in the first embodiment, the second data region 310 is in the second USD drive 300, and the second USB drive 300 has contact terminals 321 of a USB connector 320 and a USB socket for USB series connections. The second data region 310 comprises a second configuration data region 311 and a second standard data region 312. In the present embodiment, the second USB drive 300 and the first USB drive 100 are substantially identical, and the second data region 310 further comprises a second encrypted region 312 and a second security code region 314. Moreover, two USB drives 200 and 300 may have the same appearance and dimensions. More USB drives can be arranged in series connections where the built-in data regions are controlled by the active disk management driver installed in the USB security drive 100.

The USB security drive 100 is in a series connection with the first USB drive 200. In the first embodiment, the second USB drive 300 is further in a series connection with the USB security drive 100 and the first USB drive 200. In the present embodiment, the USB security drive 100 is disposed at one end of the assembled module and the USB connector 320 of the second USB drive 300 is connected to another USB drive or to a system 10, such as a USB slot of a PC or a notebook. The configuration driver 111 of the driver region 110 of the USB security drive 100 will access to the first configuration data region 211 and send a security code for protecting the first encryption data region 213 by encryption/decryption. The memory management driver 113 will integrate the first standard data region 212 and the second standard data region 312 to provide a single disk region with a combined memory capacity which will be described in detail later. Therefore, with the implementation of USB record carriers and a related assembled module according to the present invention, the USB security drive 100 can be plugged and unplugged at a user's choice. Before connecting the USB security drive 100, the system 10 only can read, copy, or modify the data stored in the first standard data region 212 of the first USB drive 200 and in the second standard data region 312 of the second USB drive 300 where the first encryption data region 213 and the second encryption data region 313 are hidden. Preferably, the USB security drive 100 further provides a specific data-transferring rerouting path such as a jumper. In order to transfer the data stored in the first encryption data region 213 to the system 10, the stored data may first be transferred to the USB security drive 100 disposed at one end of the assembled module, then sent to the system 10 through the USB drives 100 and 200 in series connection. When the USB security drive 100 is unplugged, the first encryption data region 213 is disconnected from the system 10 and can not be accessed, and the security code cannot be decrypted.

In a more specific structure, the second USB drive 300 has the same components as the first USB drive 200, such as the second encryption data region 313 and the second security code region 314 where the second security code region 314 is connected to the USB security drive 100 in a series connection. When in a series connection, the configuration driver 111 of the driver region 110 of the USB security drive 100 will access the second configuration data region 311 and send out a security code for protecting the second encryption data region 313 by encryption/decryption. Preferably, the memory management driver 113 further integrates the first encrypted data region 213 and the second encrypted region 313 as one disk region with a combined memory capacity. When the second USB drive 300 is not connected, the integrated encrypted data cannot be accessed even with the plugged USB security drive 100, thereby achieving secure protection of integrated disks with multi-level security.

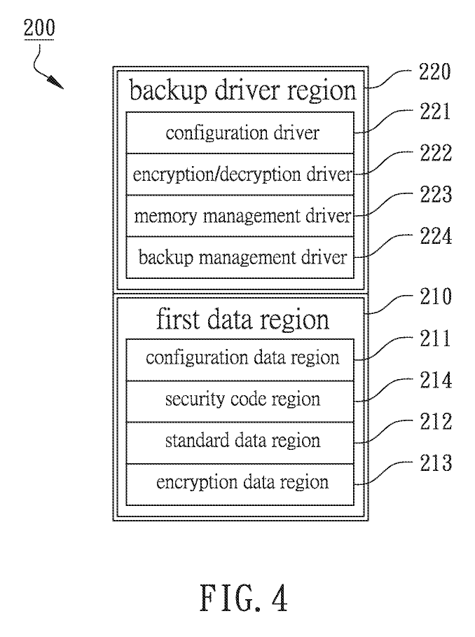

As shown in FIG. 3, in the second embodiment, the second data region 310 can be in the USB security drive 100 to eliminate the series connection of one USB drive. Preferably, as shown in FIG. 4, the first USB drive 200 further has a backup driver region 220 where the firmware components, such as the configuration driver 221, the encryption/decryption driver 222, the memory management driver 223, and the backup management driver 224, are identical to the components in the driver region 110 of the USB security drive 100, which correspond to the components 111, 112, 113, and 114 in the driver region 110 shown in FIG. 3. Moreover, the functions of the firmware components 221, 222, 223, and 224 are hidden. Preferably, the first USB drive 200 and the USB security drive 100 have the same appearances. The USB security drive 100 has a USB socket 130 with a plurality of contact terminals 131 disposed in the USB socket 130, and the location of the USB socket 130 corresponds to one end of the USB connector 120. Therefore, the USB drive 200 and the USB security drive 100 have the same hardware structures and can be mass produced in a manner that can be easily adjusted and configured d by the manufacturer or the end users.

The implementation of USB record carriers and the assembled module are illustrated according to the first embodiment in the following figures.

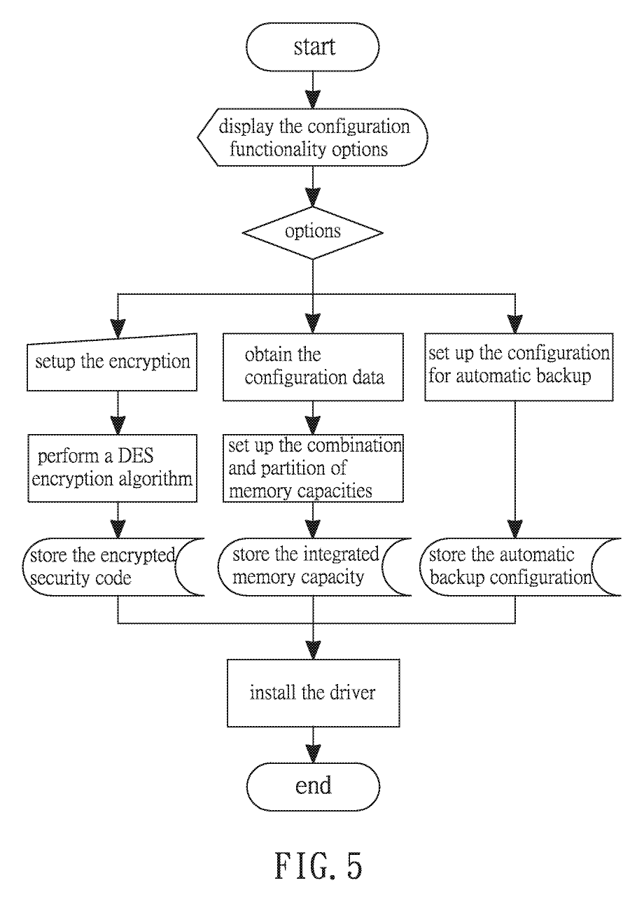

FIG. 5 is an initialization process flowchart of the built-in configuration driver. Since all the components and mechanisms of the USB drives 200, 300 and the USB security drive 100 are serially connected, the configuration driver can be executed from the system 10.

Firstly, the configuration functionality options are displayed. In the present embodiment, the initialization has at least two options: the setup of encryption/decryption and the setup of memory capacity partitions. To be more specific, the initialization further comprises an option for setting the configuration for automatic backup purposes. The options are chosen by the users, and a detailed description of configuration sub-processes of each option is discussed in the following.

As shown in FIG. 5, during the setup procedure of the encryption/decryption processes, the system 10 sends out an encrypted code or a file including the encrypted code. Then, the USB security drive 100 performs a DES encryption algorithm. Finally, the encrypted security code is stored in the first security code region 214 of the first data region 210 or in the second security code region 314 of the second data region 310.

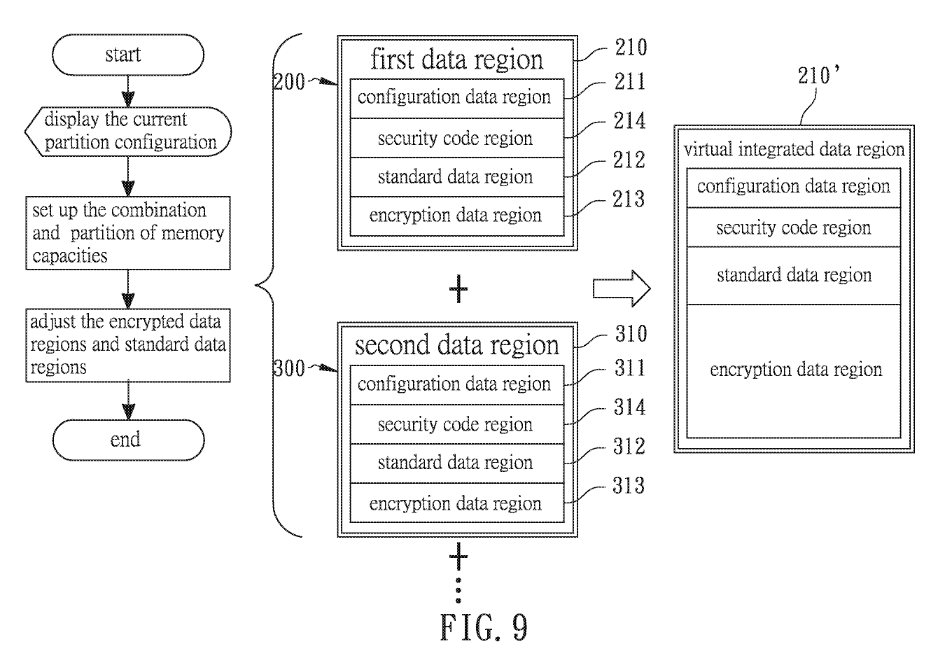

During the setup of the memory capacity partition, the configuration driver 111 accesses into the first configuration data region 211 and the second configuration data region 311, and a system 10 can obtain the data stored in the first USB drive 200 and the second USB drive 300 or other serially connected USB drives through the USB security drive 100. Then, the memory capacities can be integrally divided to increase cooperative memory capacities. Finally, the integrated memory capacity completes. As shown in FIG 9, the data stored in the first data region 210 and the second data region 310 in either USB drives 200 and 300 or in USB drive 200 and the USB security drive 100 can be accessed through the memory management driver 113 to provide an integrated virtual data region 210′ to achieve expanded memory capacities as a single disk.

During the setup of the configuration for automatic backups, the automatic backup configuration is first set up, and then the automatic backup configuration is stored in the first configuration data region 211 and the second configuration data region 311 of the USB drives 100 and 200.

When all the configuration sub-processes are finished, the driver can be installed in the driver region 110 of the USB security drive 100 to end the initialization process.

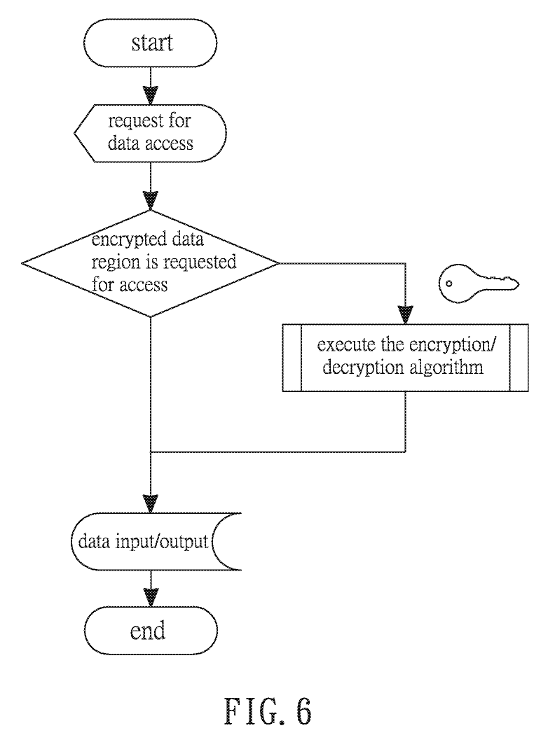

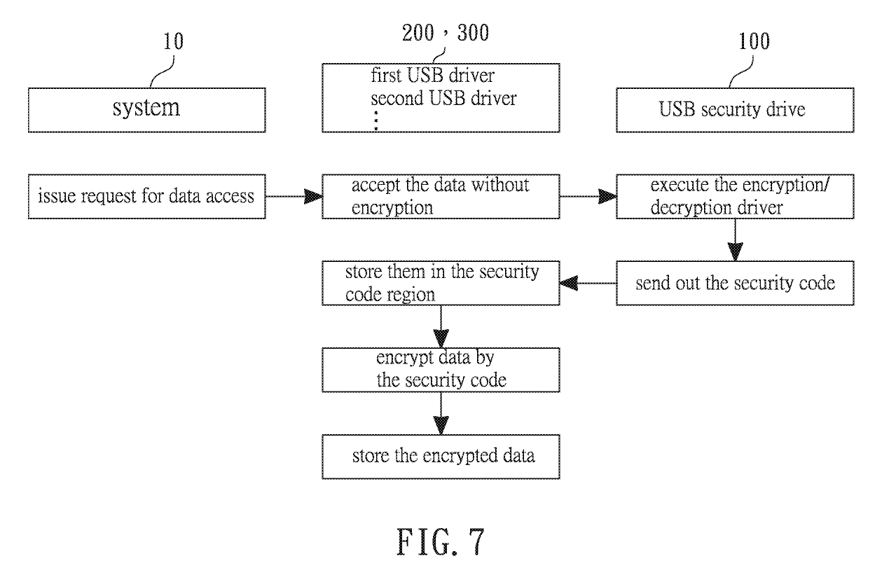

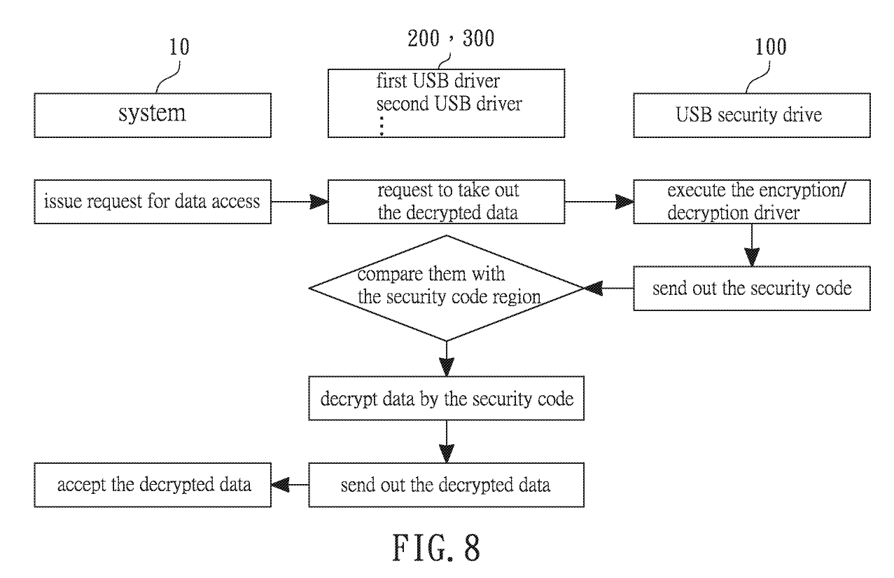

FIG. 6 is an encryption/decryption process flowchart according to the present invention. When there is a request for data access, the system 10 decides which data region can be accessed, whether the standard data regions or the encryption/decryption data region. If an encrypted data region is requested for access, then the encryption/decryption algorithm of the USB security drive 100 is executed to decide whether the data stored in encrypted data regions 132 and 232 of the USB drives 100 and 200 can be accessed or not. A specific data encryption algorithm process between different USB drives is shown in FIG. 7 and a specific data decryption algorithm process between different USB drives is shown in FIG. 8. Furthermore, if a standard data region is requested for access, then the data stored in the standard data regions 212 and 312 of the USB drives 200 and 300 can be accessed without the approval of the USB security drive 100 for data input/output and without encryption/decryption operations.

In a more specific application of the first embodiment according to the present invention, management of integrating memory capacities can be implemented by memory management applications, such as a combination of memory capacities, memory partitions between the encrypted data regions and the standard data regions, error management, etc., for two or more USB drives 200 and 300 with the USB security drive 100 located at one end of the assembled module in a series connection. FIG. 9 is a memory capacity expansion management process flowchart. The current partition configuration is displayed first, then the combination and partition of memory capacities is set up; moreover, the partition of memory capacity of encrypted data regions and standard data regions can be adjusted as requested. Finally, a virtual integrated data region 210′ is set up and includes a standard data region, which is the combination of the first standard data region 212 and the second standard data region 312. Moreover, the encrypted data region of the virtual integrated data region 210′ is the combination of the first encrypted data region 212 and the second encrypted region 312. The advantage of this embodiment is that the security protection can be greatly enhanced. Once the sequence of the series connections of USB dives 100 and 200 is different or one of the UBS drive is missing and not connected, even with the series connection of USB security drive 100, the encrypted data region of the virtual integrated data region 210′ cannot be accessed.

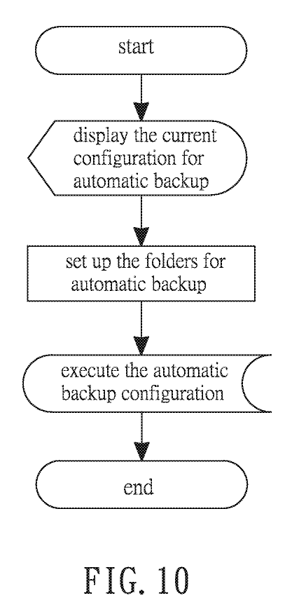

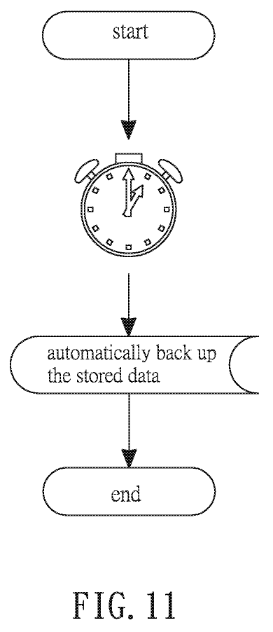

In another embodiment of the present invention, the assembled module in series connection can execute automatic backups to prevent accidental loss stored data. FIG. 10 is an automatic backup management process flowchart. The current configuration for automatic backups is displayed, folders for automatic backup are set up, and the automatic backup configuration is executed to initialize the automatic backup. As shown in FIG. 11, during an automatic backup operation process, when a specific countdown timer counts to zero, the backup folders set up by the configuration for automatic backups precedes the automatic backup operation. The data stored in the first data region 210 is automatically backed up to the second data region 310 or automatically backs up the data stored in the second data region 310 to the first data region 210.

The above description of embodiments of this invention is intended to be illustrative but not limiting. Other embodiments of this invention will be obvious to those skilled in the art in view of the above disclosure.

What is claimed is:

1. A method for utilizing USB record carriers comprising:
providing a USB security drive including a driver region;
providing a first data region in a first USB drive, wherein the first data region includes a first standard data region, and a first encrypted data region;
providing a second data region in a second USB drive or in the USB security drive, wherein the second data region includes a second standard data region; and
assembling the USB security drive and the first USB drive in series, wherein the USB security drive provides a security code for protecting the first encrypted data region, and integrates the first standard data region and the second standard data region to provide a single disk region.

2. The method as claimed in claim 1 wherein the driver region comprises a configuration driver, an encryption/decryption driver, and a memory management driver; the first data region further comprises a first configuration data region, and a first security code region; and the second data region further includes a second configuration data region; and
wherein the configuration driver in the driver region of the USB security drive accesses the first configuration data region and provides the security code for protecting the first encrypted data region, and the memory management driver integrates the first standard data region and the second standard data region to provide a single disk region.

3. The method as claimed in claim 2, wherein the second data region further includes a second encrypted data region and a second security code region, wherein the configuration driver in the driver region of the USB security drive accesses the second configuration data region and provides a security code for protecting the second encrypted data region.

4. The method as claimed in claim 3, wherein the memory management driver integrates the first encrypted data region and the second encrypted data region to provide a single disk region.

5. The method as claimed in claim 3, wherein the second data region is in the USB security drive and the first USB drive further includes a backup driver region such that the first USB drive and the USB security drive have the same hardware structure.

6. The method as claimed in claim 1, wherein the driver region further comprises a backup management driver to automatically backup the first data region and the second data region.

7. The method as claimed in claim 1, wherein the USB security drive further includes a jumper to provide an electrical rerouting path for the first encrypted data region.

8. An assembly of USB record carriers comprising:
a USB security drive including a driver region;
a first data region in a first USB drive, wherein the first data region includes a first standard data region, and a first encrypted data region; and
a second data region in a second USB drive or in the USB security drive, wherein the second data region includes a second standard data region;
wherein the USB security drive and the first USB drive are serially connected; wherein the USB security drive provides a security code for protecting the first encrypted data region, and integrates the first standard data region and the second standard data region to provide a single disk region.

9. The assembly as claimed in claim 8 wherein the driver region comprises a configuration driver, an encryption/decryption driver, and a memory management driver; the first data region further comprises a first configuration data region, and a first security code region; and wherein the second data region further comprises a second configuration data region;
wherein the configuration driver in the driver region of the USB security drive accesses the first configuration data region and provides a security code for protecting the first encrypted data region, and the memory management driver integrates the first standard data region and the second standard data region to provide a single disk region.

10. The assembly as claimed in claim 9, wherein the second data region further comprises a second encrypted data region and a second security code region, wherein the configuration driver in the driver region of the USB security drive accesses the second configuration data region and provides a security code for protecting the second encryption data region.

11. The assembly as claimed in claim 10, wherein the memory management driver integrates the first encrypted data region and the second encrypted data region to provide a single disk region.

12. The assembly as claimed in claim 8, wherein the second data region is in the USB security drive and the first USB drive further includes a backup driver region so that the first USB drive and the USB security drive have the same hardware structure.

13. The assembly as claimed in claim 8, wherein the driver region further comprises a backup management driver to automatically backup the first data region and the second data region.

14. The assembly as claimed in claim 8, wherein the USB security drive further comprises a jumper to provide an electrical rerouting path for the first encrypted data region.
